(19) United States
(12) Patent Application Publication
(10) Pub. No.: US 2009/0245068 A1
(43) Pub. Date: Oct. 1, 2009

(54) OPTICAL PICKUP DEVICE AND OPTICAL DISC DRIVE

(75) Inventors: Hiroshi KAYAMA, Osaka (JP); Kazuo MOMOO, Osaka (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(73) Assignee: PANASONIC CORPORATION, Kadoma-shi (JP)

(21) Appl. No.: 12/412,630

(22) Filed: Mar. 27, 2009

(30) Foreign Application Priority Data
Mar. 31, 2008 (JP) 2008-091089

(51) Int. Cl. G11B 7/00

(52) U.S. Cl. 369/100; G9B/7

(57) ABSTRACT

An optical pickup device according to the present invention includes: first and second light sources that are driven selectively and that emit blue and red light beams, respectively; an optical element for splitting the blue and red light beams emitted into main and sub-blue beams and main and sub-red beams, respectively; first and second photodetectors that receive the main and sub-blue beams reflected from the optical disc, thereby outputting electrical signals; and third and fourth photodetectors that receive the main and sub-red beams reflected from the optical disc, thereby outputting electrical signals. A dead zone that outputs no electrical signal representing the intensity of the light received is provided for respective parts of the second and fourth photodetectors.

### BACKGROUND OF THE INVENTION

1. Field of the Invention

The present invention relates to an optical pickup device and an optical disc drive including the same optical pickup device.

2. Description of the Related Art

An optical pickup device including a plurality of light sources that operate at mutually different wavelengths and photodetectors that are provided for the respective light sources, i.e., a so-called “multi-wavelength optical pickup device”, has been developed. Examples of such multi-wavelength optical pickup devices include a three-wavelength optical pickup that has a light source that operates at a wavelength falling within the blue spectral range for Blu-ray Discs (BDs), a light source that operates at a wavelength falling within the red range for DVDs, and a light source that operates at an infrared wavelength for CDs.

Some of those optical disc drives perform a tracking control by a so-called “three-beam method”, according to which a single light beam emitted from a light source is split into one main beam and two sub-beams using a diffraction grating, for example. Those main and sub-beams are incident on, and reflected from, a given optical disc. The two sub-beams reflected then impinge on their associated photodetectors at regular intervals before and after the main beam hits its associated photodetector. And by receiving the main and sub-beams at their associated photodetectors, the tracking error that has occurred during the tracking control can be detected.

FIG. 6 illustrates how photodetectors may be arranged in a three-wavelength optical pickup device when the three-beam method is adopted. In this example, photodetectors 201 to 203 to receive the light reflected from a BD and a DVD and photodetectors 204 to 206 to receive the light reflected from a CD are provided.

If a blue laser diode (which will be abbreviated herein as “LD”) has emitted a light beam, a first type of photodetector 201 receives the reflected beam 207 of its main beam, while a second type of photodetectors 202 and 203 receive the reflected beams 208 and 209 of the sub-beams that have been emitted from the blue LD. On the other hand, if a red LD has emitted a light beam, the first type of photodetector 201 receives the reflected beam 207 of its main beam, while the second type of photodetectors 202 and 203 receive the reflected beams 208 and 209 of the sub-beams that have been emitted from the red LD.

Furthermore, if an infrared LD has emitted a light beam, a third type of photodetector 204 receives the reflected beam of its main beam, while a fourth type of photodetectors 205 and 206 receive the reflected beams of the sub-beams.

FIG. 7 shows the relation between the optical axis of a blue light beam that has been emitted from the blue LD of a blue LD package 102 and those of red and infrared light beams that have been emitted from the red and infrared LDs of a red/infrared LD package 103.

The optical axis 153 of the light beam that has been emitted from the red LD of the red/infrared LD package 103 is generally adjusted so as to agree with the optical axis 152 of a light beam that has been emitted from the blue LD package 102 after the former light beam has been transmitted through, or reflected from, a polarization beam splitter (which will be abbreviated herein as “PBS”) 106. As a result, every light beam reflected from the optical disc is received with the photodetectors 201, 202 and 203 used in common. Such an arrangement is adopted because the red light beam, which has a shorter wavelength than the infrared light beam, is more easily affected by various types of aberrations, inconstant distributions, or any other kind of variation. Meanwhile, the infrared LD is arranged so as to have an offset with respect to the red LD on the red/infrared LD package 103. That is why the infrared light beam is received by the photodetectors 204, 205 and 206.

Now take a look at FIG. 6 again. As for BDs and DVDs, a focus error signal FE is calculated by the following Equation (1):

FE=(A+C)−(B+D)+k{(E+G+I+K)−(F+H+J+L)} (1)

where A through L denote the respective photosensitive areas of the photodetectors 201 and 203 shown in FIG. 6. The same can be said about the next equation, too.

On the other hand, a tracking error signal TE is calculated by the following Equation (2):

TE=(A+B)−(C+D)−m{(E+F+I+J)−(G+H+K+L)} (2)

The k value in Equation (1) is normally defined so as to reduce the disturbance that would be caused by the guide groove of the optical disc (not shown) in the focus error signal while a focus control is being performed. On the other hand, the m value in Equation (2) is normally defined so as to reduce or cancel the offset that would be caused in the tracking error signal when the objective lens 113 follows the eccentric pattern of the guide groove of the optical disc while a tracking control is being performed. It should be noted that focus error and tracking error signals for CDs could also be defined in a similar manner by using the photodetectors 204, 205 and 206.

The arrangement shown in FIG. 6 is well known in the art.

For example, Japanese Patent Application Laid-Open Publication No. 2005-303004 discloses three-wavelength photodetectors, which include a photodetector dedicated to BDs and a photodetector for use in DVDs and BDs. On the other hand, Japanese Patent Application Laid-Open Publication No. 2005-327403 discloses that a single photodetector could be used by combining the optical axes of the light beams together. Meanwhile, Japanese Patent Application Laid-Open Publication No. 2006-40411 discloses a photo sensor for use only in DVDs and a photo sensor for use in both VBDs and CDs. And Japanese Patent Application Laid-Open Publication No. 2007-287232 discloses means for providing an opaque zone or a dead zone with a predetermined size for a central portion of a sub-beam receiving area in order to stabilize the tracking control that would be disturbed due to the interference in a multilayer storage disc.

When a dual-layer disc such as a BD-R or a BD-RE is played with a blue LD, the light beams 207, 208 and 209 reflected from a target layer to scan (which will be referred to herein as a “target storage layer”) and the light beam 210 reflected from the other non-target storage layer will interfere with each other on the photodetectors as shown in FIG. 6. Strictly speaking, interference will also be caused by the light reflected from the surface of the optical disc. However, such reflected light can be neglected because its light intensity is lower than that of the light reflected from the other storage layer.

Normally, the one main beam and the two sub-beams will have an intensity ratio of approximately 10 to 1 to 1.

Compared to the main beam 207 that has been reflected back from the target storage layer, the main beam 210 reflected from the other layer has a significantly expanded beam spot due to the occurrence of a focus error but a sufficiently decreased light intensity (which may have been decreased by two digits, for example). Therefore, the main beam reflected from the other storage layer will have only a little impact. Such a focus error is caused due to the thickness of the intermediate layer between the two storage layers. Likewise, the sub-beams 208 and 209 reflected from the target storage layer are also hardly affected by the sub-beam (not shown) reflected from the other storage layer.

Meanwhile, the difference between the light intensity of the sub-beams 208 and 209 reflected from the target storage layer and that of the main beam 210 reflected from the other storage layer is just one digit, and therefore, is non-negligible.

As a result, the sub-beams 208 and 209 reflected from the target storage layer and the main beam 210 reflected from the other storage layer will interfere with each other on the photodetectors 202 and 203, thus producing interference fringes there.

If the interlayer thickness at the target read location on the optical disc 101 varies finely due to a manufacturing error, for example, then the difference in phase between the light reflected from the target storage layer and the light reflected from the other storage layer will also vary, thus moving those interference fringes on the photodetectors. As a result, the focus error and tracking error signals will fluctuate and the servo control may lose its stability.

Japanese Patent Application Laid-Open Publications No. 2005-303004, No. 2005-327403 and No. 2006-40411 disclose examples of optical pickup devices compliant with the three optical disc standards for BDs, DVDs and CDs. In those optical pickup devices, the servo control could lose its stability due to the interference between the light reflected from the target storage layer and the light reflected from a non-target storage layer in a multilayer disc for the reasons described above.

On the other hand, as disclosed in Japanese Patent Application Laid-Open Publication No. 2007-287232, if an opaque zone or a dead zone with a predetermined size is provided for a central portion of the sub-beam receiving area, then it may be possible to reduce the fluctuation of the servo signals that would be caused due to the interference occurring while a read/write operation is being performed on a dual-layer disc or a disc with a greater number of storage layers. Such a technique is effectively applicable to not just multilayer BD-R and BD-RE discs but also dual-layer DVD±R and DVD-RW discs as well. However, if information were read or written from/on a DVD-RAM, which has a broader guide groove width than a DVD±R or a DVD-RW, then ±first-order light diffracted by the guide groove would enter the central portion of the sub-beam receiving area. That is why if the dead zone as disclosed in that document were provided in such a situation, then the tracking control signal would have a decreased level, thus possibly threatening the stability of the tracking control.

### SUMMARY OF THE INVENTION

It is therefore an object of the present invention to provide an optical pickup device and an optical disc drive that can not only reduce the fluctuation of the servo signals that will be caused due to the interference occurring on photodetectors while a read/write operation is being performed on any of various kinds of multilayer storage discs such as BD-R, BD-RE, DVD±R and DVD-RW but also get the read/write operation done with good stability even on an optical disc with a different guide groove width such as a DVD-RAM.

An optical pickup device according to the present invention can perform read and/or write operation(s) on an optical disc with multiple storage layers. The device includes: first and second light sources that are driven selectively and that emit blue and red light beams, respectively; an optical element for splitting the blue and red light beams emitted into main and sub-blue beams and main and sub-red beams, respectively; first and second photodetectors that receive the main and sub-blue beams that have been emitted from the first light source and then reflected from the optical disc, thereby outputting electrical signals representing the intensities of the light received; and third and fourth photodetectors that receive the main and sub-red beams that have been emitted from the second light source and then reflected from the optical disc, thereby outputting electrical signals representing the intensities of the light received. A dead zone that outputs no electrical signal representing the intensity of the light received is provided for respective parts of the second and fourth photodetectors.

The dead zone may be provided for the second photodetector so as to cross the second photodetector in a direction A corresponding to a tangential direction for the optical disc.

The dead zone may be provided for the fourth photodetector so as to cross the fourth photodetector in the direction A.

Supposing the dead zones of the second and fourth photodetectors have widths W1 and W2, respectively, W1>W2 may be satisfied.

The dead zones may be provided for the second and fourth photodetectors so as to cross the second and fourth photodetectors in a direction B corresponding to the radial direction of the optical disc.

The second photodetector may be divided into four photosensitive areas, and the dead zone may be arranged in a cross shape between the four photosensitive areas of the second photodetector.

The fourth photodetector may also be divided into four photosensitive areas, and the dead zone may be arranged in a cross shape between the four photosensitive areas of the fourth photodetector.

Supposing the dead zones of the second and fourth photodetectors have widths W1 and W2, respectively, in a direction B corresponding to the radial direction of the optical disc, and widths Y1 and Y2, respectively, in a direction A corresponding to a tangential direction for the optical disc, W1≧Y1 and W2≧Y2 may be satisfied.

Supposing the dead zones of the second and fourth photodetectors have widths W1 and W2, respectively, in the direction B, W1>W2 may be satisfied.

Supposing the dead zones of the second and fourth photodetectors have widths Y1 and Y2, respectively, in the direction A, Y1>Y2 may be satisfied.

The optical pickup device may further include a third light source that emits an infrared light beam. In that case, the first, second and third light sources may be driven selectively. The optical element may split the infrared light beam emitted into main and sub-infrared beams. The first and second photodetectors may receive the main and sub-infrared beams, respectively, which have been reflected from the optical disc.

The second photodetector may receive the main blue beam that has been reflected from a non-target storage layer that is different from the target storage layer on which the read/write operation needs to be performed.

The fourth photodetector may receive the main red beam that has been reflected from a non-target storage layer that is different from the target storage layer on which the read/write operation needs to be performed.

An optical disc drive according to the present invention includes: an optical pickup device according to any of the preferred embodiments of the present invention described above; a driver section for driving the first and second light sources of the optical pickup device; and a servo section for performing a tracking control with a tracking error signal that has been generated based on either the electrical signals supplied from the first and second photodetectors of the optical pickup device or the electrical signals supplied from the third and fourth photodetectors of the optical pickup device.

The optical pickup device and optical disc drive of the present invention define the sub-beam division boundary of a quadruple photodetector in a direction corresponding to the tracking radial direction, and does not detect it as a dead zone, in each of a photodetector for use in common in BDs and CDs and a photodetector for DVDs. By avoiding detecting light in an area where the interference fringes have two significantly different intensities, the fluctuation of a tracking error signal can be minimized in a multilayer optical disc such as a BD or a DVD.

Also, in a photodetector for use in DVDs, which are classifiable into two groups that are compliant with two standards that adopt mutually different track pitches (i.e., DVD-RAMs and the other types of DVDs), the division boundary in the direction corresponding to the (disc) radial direction has its shielding width made either narrower than that of BDs or CDs or even equal to zero. As a result, not just can the fluctuation of the tracking error signal be reduced in multilayer DVDs but also can the harmful effect of shielding on the tracking error signal be reduced significantly in a DVD-RAM, on which the ±first-order diffracted light that has come from the guide groove is incident closer to the center of light beam spot on a photodetector compared to any other recordable DVD.

Furthermore, by defining the sub-beam division boundary of a quadruple photodetector in a cross shape, and not detecting it as a dead zone, for the photodetector for use in common in BDs and CDs and the photodetector for DVDs, the fluctuation could be reduced not only in the tracking error signal for multilayer BDs or DVDs but also in the focus error signal as well. On top of that, if the division boundary has a narrower width in a tangential direction, which crosses the radial direction at right angles, than in the direction corresponding to the radial direction, then not only the harmful effect on the tracking error but also the fluctuation of the focus error signal could be both reduced.

Moreover, by defining the shielding width of the division boundary of the photodetector for DVDs to be either narrower than that of BDs or CDs or even equal to zero, the detrimental influence of shielding on the tracking error signal for DVD-RAMs can be minimized.

Consequently, the present invention provides an optical pickup device and an optical disc drive that can get a read/write operation done with good stability on not just single-layer or multilayer BD-R, BD-RE, DVD±R, DVD±RW and CD discs but also even DVD-RAMs as well.

### BRIEF DESCRIPTION OF THE DRAWINGS

FIG. 1(a) illustrates a configuration for an optical disc drive 1 that can read and/or write information from/on BDs, DVDs and CDs that are compliant with three different standards and FIG. 1(b) is a cross-sectional view of this arrangement as viewed on a plane that crosses the surface of the optical disc 101 at right angles.

FIG. 2 illustrates a configuration for a photodetector unit 116.

FIG. 3 shows the relation between the optical axis of a blue light beam that has been emitted from the blue LD of the blue LD package 12 and that of the red or infrared light beam that has been emitted from the red/infrared LD package 13.

FIG. 4 illustrates, side by side, a spot 31 that sub-beams reflected from a DVD±R or a DVD±RW have left on the photodetector 5 and a spot 32 that sub-beams reflected from a DVD-RAM have left on the photodetector 5.

FIG. 5 illustrates photodetectors 41 to 46 for use in a second preferred embodiment of the present invention.

FIG. 6 illustrates how photodetectors may be arranged in a three-wavelength optical pickup device when the three-beam method is adopted.

FIG. 7 shows the relation between the optical axis of a blue light beam that has been emitted from the blue LD of a blue LD package 102 and those of red and infrared light beams that have been emitted from a red/infrared LD package 103.

### DETAILED DESCRIPTION OF PREFERRED EMBODIMENTS

Hereinafter, preferred embodiments an optical pickup device and optical disc drive according to the present invention will be described with reference to the accompanying drawings.

### Embodiment 1

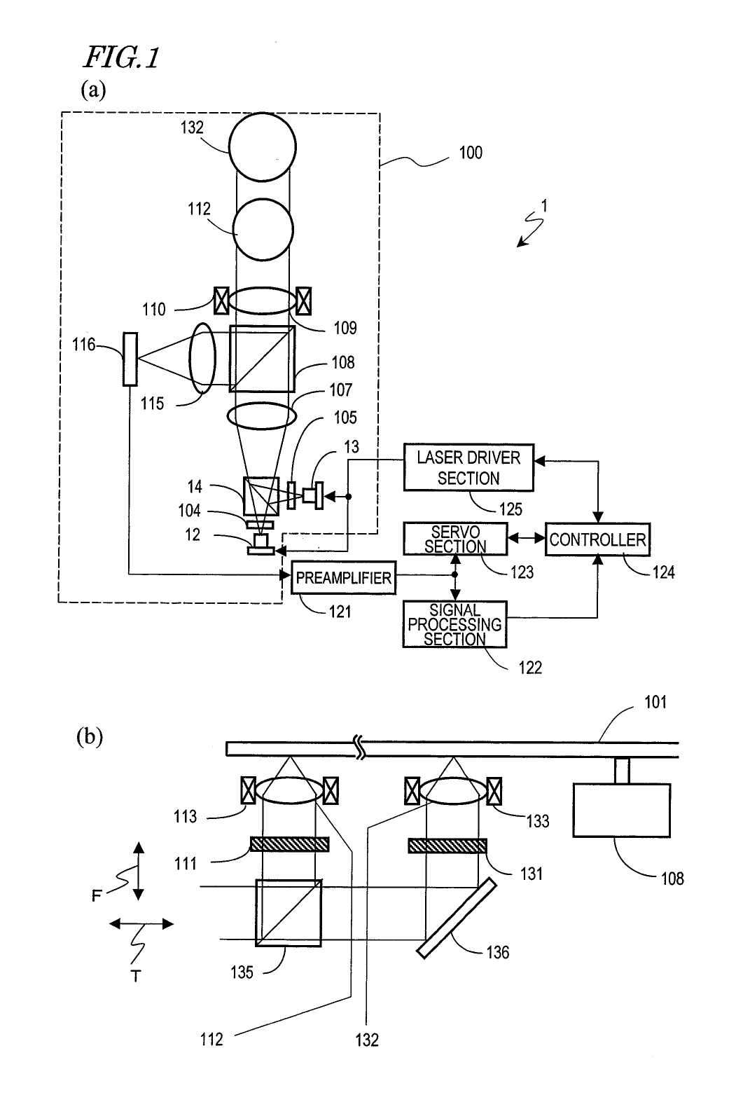

FIG. 1(a) illustrates a configuration for an optical disc drive 1 that can read and/or write information from/on BDs, DVDs and CDs that are compliant with three different standards.

The optical disc drive 1 includes an optical pickup device 100, a preamplifier 121, a signal processing section 122, a servo section 123, a controller 124, and a laser driver section 125. In some cases, the preamplifier 121 and the laser driver section 125 could be built in the optical pickup device 100.

The optical pickup device 100 is a so-called “three-wavelength compatible” type and can perform read and/or write operation(s) on an optical disc with a single or multiple storage layer(s).

First of all, it will be described how this optical pickup device works on BDs.

As shown in FIG. 1(a), in the optical pickup device 100, the light beam emitted from the blue laser diode (blue LD) of a blue LD package 12 is incident on a diffraction grating 104 and split into a zero-order main beam and ±first-order sub-beams there. The main and sub-beams are then transmitted through a first wavelength selective mirror 14, a collimator lens 107, a polarization beam splitter (which will also be abbreviated herein as “PBS”) 108 and a beam expander 109 to be condensed on the surface of an optical disc 101. FIG. 1(b) is a cross-sectional view of this arrangement as viewed on a plane that crosses the surface of the optical disc 101 at right angles. After having been transmitted through the beam expander 109, the main and sub-beams follow the optical paths shown in FIG. 1(b) to reach the optical disc 101. Specifically, the main and sub-beams pass a second wavelength selective mirror 135, a reflective mirror 136, a quarter-wave plate 131 and then an objective lens 132 to be condensed on the surface of the optical disc 101.

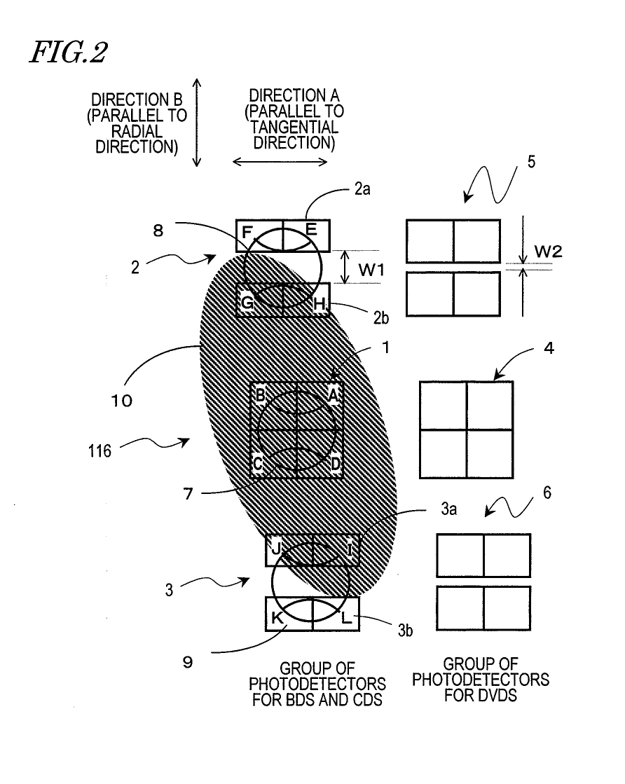

The light reflected from the optical disc is transmitted again through the objective lens 132, the quarter-wave plate 131, the reflective mirror 136, the second wavelength selective mirror 135, the beam expander 109, the PBS 108 and then a detector lens 114 to be condensed on a photodetector 115. In response, the photodetector unit 116 outputs an electrical signal (which will be referred to herein as a “detection signal”), representing the intensity of the incident light, to the preamplifier 121, which generates a focus error (FE) signal, a tracking error (TE) signal and an RF signal based on the detection signal. The FE signal can be calculated by Equation (1) and the TE signal by Equation (2). It should be noted that the reference signs A through L included in Equations (1) and (2) correspond to the ones shown in FIG. 2 as will be described later. Also, the RF signal is generated as a sum signal (A+B+C+D) of the main beam that has been reflected from the optical disc 101.

The signal processing section 122 receives the RF signal and extracts and decodes the stored information (data) and address information from it. The servo section 123 receives the FE and TE signals, gets the objective lens 132 and the beam expander 109 controlled by actuators 133 and 110, and also controls a spindle motor 108. The laser driver section 125 controls the radiation power of the blue LD of the blue LD package 12 for use to perform a read/write operation. The controller 124 receives information from the servo section 123 and the signal processing section 122 and controls the overall optical disc drive 1. For example, the controller 124 may instruct the laser driver section 125 on the radiation power of the light beam. Or the controller 124 may send the decoded information to a high-order device (not shown) and receive the data to be written on the optical disc 101.

Next, it will be described how this optical pickup device works on DVDs and CDs.

The light beam that has been emitted from one of red and infrared laser diodes (which will be referred to herein as “red LD” and “infrared LD”, respectively), which are built in a red/infrared LD package 13 as second and third light sources for red and infrared beams, respectively, is incident on the diffraction grating 104 and split into a zero-order main beam and ±first-order sub-beams there. The main and sub-beams are then reflected by the first wavelength selective mirror 14 and transmitted through the collimator lens 107, the PBS 108, the beam expander 109, the second wavelength selective mirror 135, the quarter-wave plate 111 and the objective lens 112 to be condensed on the surface of an optical disc 101. The light beam reflected from the optical disc is transmitted again through the objective lens 132, the quarter-wave plate 111, the second wavelength selective mirror 135, the beam expander 109, the PBS 108 and then the detector lens 114 to be condensed on a photodetector 115.

FIG. 2 illustrates a configuration for the photodetector unit 116, which includes a first type of photodetector 1, two second type of photodetectors 2 and 3, a third type of photodetector 4, and two fourth type of photodetectors 5 and 6.

The first type of photodetector 1 has photosensitive areas A, B, C and D and receives the reflected main beams from the blue and infrared LDs. Meanwhile, the second type of photodetectors 2 and 3 receive reflected sub-beams from the blue and infrared LDs.

Specifically, the second type of photodetector 2 includes a photosensitive section 2a consisting of photosensitive areas E and F and a photosensitive section 2b consisting of photosensitive areas G and H. The gap between the photosensitive sections 2a and 2b will be identified herein by W1. In this description, this gap will be referred to herein as a “dead zone”, which means that even if this zone has received light, no electrical signal representing the intensity of that light is output. For example, if the photosensitive sections 2a and 2b are two different members that are arranged totally separately from each other on a substrate, then an area on the surface of the substrate, which is located between the photosensitive sections 2a and 2b and which has no photosensitive function at all, is the dead zone. On the other hand, if the photosensitive sections 2a and 2b form integral parts of the second type of photodetector 2, then the area with no photosensitive function between the photosensitive sections 2a and 2b (e.g., an area with an opaque material) becomes the dead zone. In this preferred embodiment, the dead zone is arranged in a direction A, corresponding to a tangential direction for the optical disc, and crosses the second photodetector 2.

The other photodetector 3 of the second type includes a photosensitive section 3a consisting of photosensitive areas J and I and a photosensitive section 3b consisting of photosensitive areas K and L. In this preferred embodiment, the gap between the photosensitive sections 3a and 3b is also W1 (not shown). However, these gaps do not always have to be the same between these two photodetectors 2 and 3 of the second type. As in the second type of photodetector 2, a dead zone is also arranged between the photosensitive sections 3a and 3b.

The third type of photodetector 4 receives the reflected main beam from the red LD. Meanwhile, the fourth type of photodetectors 5 and 6 receive the reflected sub-beams from the red LD.

Just like the second type of photodetectors 2 and 3, the fourth type of photodetectors 5 and 6 also have a dead zone, of which the width will be identified herein by W2. The widths W1 and W2 are defined so as to satisfy W1>W2.

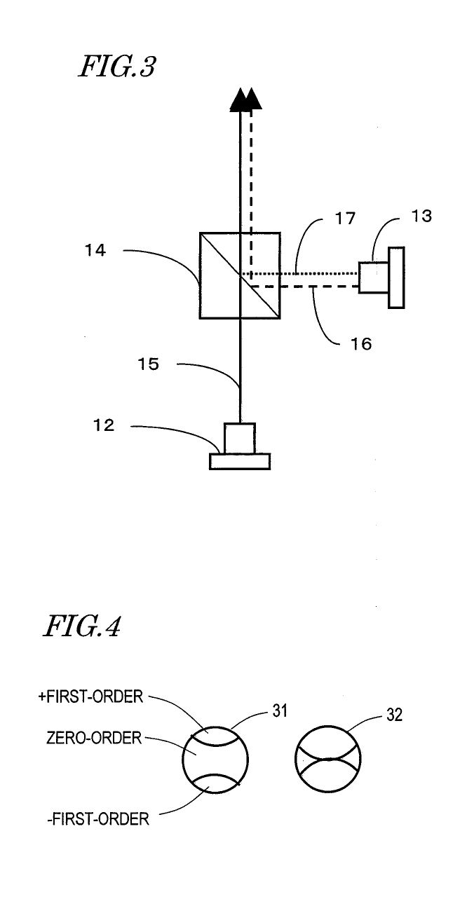

FIG. 3 shows the relation between the optical axis of a blue light beam that has been emitted from the blue LD of the blue LD package 12 and that of the red or infrared light beam that has been emitted from the red/infrared LD package 13. In this preferred embodiment, the optical axis 17 of the light beam that has been emitted from the infrared LD is adjusted so as to agree with the optical axis 15 of the light beam that has been emitted from the blue LD on its optical path away from the PBS 14. As a result, the light beams that have been emitted from the respective light sources and then reflected from the optical disc are eventually received using the photodetectors 1, 2 and 3 in common. Since the red LD is arranged on the red/infrared LD package 13 so as to have an offset with respect to the infrared LD, the light beam that has been emitted from the red LD and then reflected from the optical disc is received by the photodetectors 4, 5 and 6.

If information is read from a dual-layer disc such as a BD-R or a BD-RE with the light beam emitted from the blue LD, then the main beam 7 that has been reflected from the target storage layer and the main beam 10 that has been reflected from the other storage layer will interfere with each other on the photodetector 1, thus producing interference fringes of light there. However, the intensity of the light 10 reflected from the other storage layer is smaller than that of the light 7 reflected from the target storage layer by about two digits and each of these reflected light beams 7 and 10 is incident on the photodetector 1 point-symmetrically. That is why the main tracking error signal generated by the first photodetector 1 will be affected only a little.

In the photodetectors 2 and 3, on the other hand, the sub-beams 8 and 9 reflected from the target storage layer, the main beam 10 reflected from the other storage layer and the sub-beams (not shown) reflected from the other storage layer will interfere with each other. Since the intensity of the main beam 10 reflected from the other storage layer is smaller than that of the sub-beams 8 and 9 reflected from the target storage layer by only one digit, the interference will have significant influence. Meanwhile, as the intensity of the sub-beams reflected from the other layer is smaller than that of the main beam 10 reflected from the other storage layer by about one digit, the influence of their interference will be too little to take into account.

Thus, as for the photodetectors 2 and 3, the central area that receives only the zero-order diffracted light of the sub-beams that have been reflected from the guide groove of the target storage layer of the optical disc and that comes to have an increased light intensity is preferably shielded as a dead zone and the shielding width W1 thereof is preferably determined so that the photodetectors 2 and 3 receive light including the ±first-order diffracted light beams and zero-order diffracted light beam. As a result, without decreasing the AC components (i.e., components representing the light that has crossed the groove) of the sub-beams' tracking error signal that has been generated by the photodetectors 2 and 3, the components of interference between the main beam 10 reflected from the other storage layer and the central zero-order diffracted light with a high light intensity can be removed efficiently. As a result, the tracking error signal of the sub-beams can be stabilized with its fluctuation reduced. It should be noted that a single-layer BD or CD should be able to be played with no problem at all because no interference should be produced with the light reflected from another or the other storage layer.

On the other hand, if information is read from any of various types of DVDs with a light beam emitted from the red LD, then the light reflected from the optical disc is received at the photodetectors 4, 5 and 6. Those various DVDs include a DVD-RAM, which has a broader guide groove width than a DVD±R or a DVD±RW. FIG. 4 illustrates, side by side, a spot 31 that sub-beams reflected from a DVD±R or a DVD±RW have left on the photodetector 5 and a spot 32 that sub-beams reflected from a DVD-RAM have left on the photodetector 5. As shown in FIG. 4, the ±first-order light beams reflected from the DVD-RAM are in closer proximity to the center of the spot than the ±first-order light beams reflected from the DVD±R or DVD±RW. That is why if an opaque portion were arranged at the center of the photodetector, then the AC components of the tracking error signal would be removed when the DVD-RAM is played. For that reason, to reduce the fluctuation of the STE signal in a dual-layer DVD disc, the shielding width W2 of the photodetectors 5 and 6 for DVDs is defined so as to satisfy W1>W2 in view of the degree of degradation of the tracking error signal. However, if more attention should be paid to increasing the stability of tracking servo on the DVD-RAM, then W2≈0 could be satisfied, too.

By adopting such a configuration, when a multilayer BD with two or more storage layers is played, the stability of the tracking control can be increased. And the stability of tracking control on DVDs does not decrease even when a DVD-RAM is played, and increases when dual-layer DVD disc is played.

### Embodiment 2

This second preferred embodiment of the present invention also uses the optical disc drive 1 and optical pickup device 100 with the configuration shown in FIG. 1. Thus, the following description of this preferred embodiment will be focused on the differences from the first preferred embodiment described above.

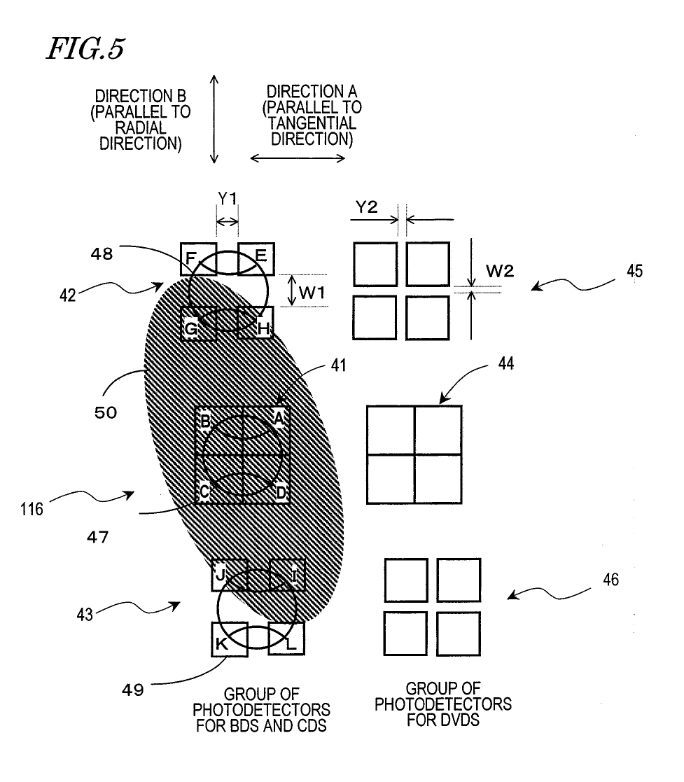

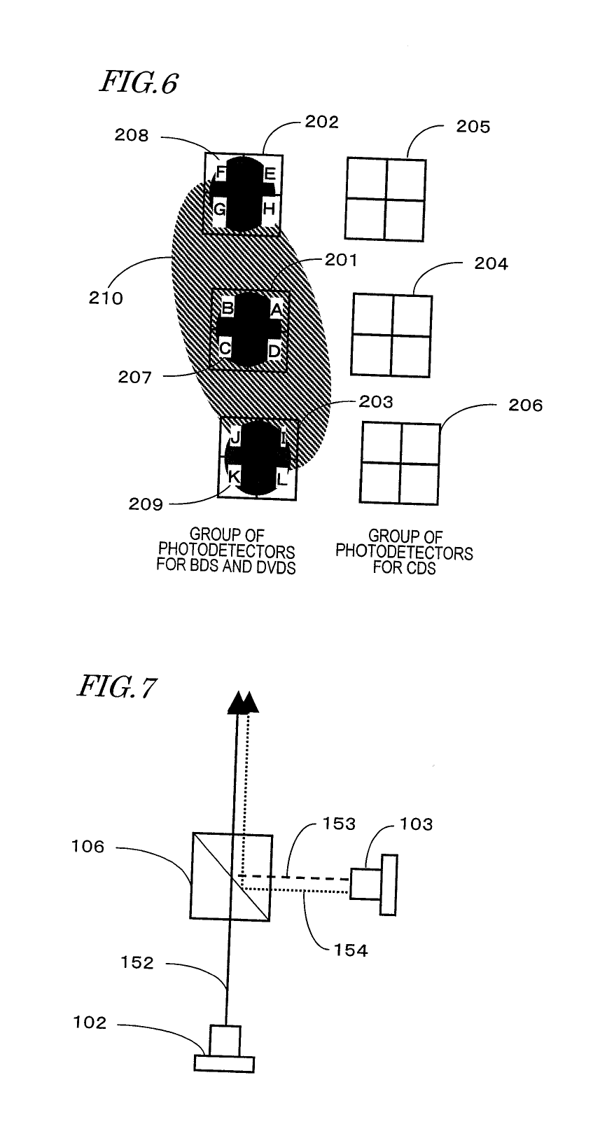

FIG. 5 illustrates photodetectors 41 to 46 for use in this preferred embodiment. These photodetectors 41 to 46 are arranged on the photodetector unit 116 shown in FIG. 1(a).

Among these photodetectors 41 to 46, each of the photodetectors 42 and 43 of the second type that receive the sub-beams when a BD or a CD is played is divided into four photosensitive areas. Specifically, the photodetector 42 is divided into photosensitive areas E, F, G and H and the photodetector 43 is divided into photosensitive areas I, J, K and L. A dead zone in a cross shape is arranged between those four photosensitive areas in each of the photodetectors 42 and 43.

The respective dead zones of the photodetector 42 and 43 have a width W1 as measured in the direction B corresponding to the radial direction of the optical disc and have a width Y1 as measured in the direction A corresponding to a tangential direction for the optical disc.

On the other hand, among these photodetectors 41 to 46, each of the photodetectors 45 and 46 of the fourth type that receive the reflected sub-beams when a DVD is played is also divided into four photosensitive areas. And a dead zone in a cross shape is arranged between those four photosensitive areas in each of the photodetectors 45 and 46. The respective dead zones of the photodetector 45 and 46 have width W2 and Y2 as measured in the directions B and A, respectively.

By adopting the configuration of this preferred embodiment, not only the stability of tracking control but also the stability of focus control would be increased as well. This is because the FE signal to be used for a focus control is indicated by E through L of Equation (1) and each photodetector is divided not just in the direction A but also in the direction B as well, and a dead zone is provided in the direction B and crosses the photodetector. By arranging the dead zone in the direction B, the influence of variations in interference fringes to be produced due to the interference between the sub-beams reflected from the target storage layer and the main beam reflected from the other storage layer can be reduced.

Nevertheless, the dead zone with the width Y1 or Y2 will cut off not only the interfering light for the multilayer disc but also ±first-order diffracted light beams that have come from the guide groove of the optical disc. That is why to stabilize the tracking control, it is preferred that W1≧Y1 and W2≧Y2 be satisfied. Optionally, if more attention should be paid to increasing the stability of a tracking or focus servo control on DVD discs including DVD-RAMs (and in single-layer DVDs, among other things), then W1>W2 (including a situation where W2≈0) or Y1>Y2 (including a situation where Y2≈0) could be satisfied, too.

In the first preferred embodiment described above, the dead zone is supposed to have either a rectangular shape elongated in only the direction A or a cross shape. Alternatively, the dead zone may also be a rectangular one that is elongated in only the direction B.

Also, in the preferred embodiments described above, the shape, location and range of the dead zone of the photodetector 2 are supposed to be the same as those of the dead zone of the photodetector 4. However, these photodetectors may also have dead zones with mutually different shapes, locations or ranges.

Furthermore, in the foregoing description of preferred embodiments, the present invention has been described as being applied to a situation where information is read from an optical disc. However, this is just an example. As described above, the optical disc drive of the present invention can also write information on an optical disc. In other words, the present invention is applicable to not just reading information from an optical disc. Rather, even when a write operation is performed, information still needs to be retrieved in order to get an address on an optical disc or verify the information written. That is why reflected light must be detected during writing, too.

Furthermore, in the preferred embodiments described above, the optical pickup device is supposed to be compatible with three wavelengths. However, this is only an example. Alternatively, the optical pickup device could also be compatible with only BDs with multiple storage layers. In that case, only the photodetectors 1, 2 and 3 will be provided in FIG. 2.

As described above, the optical pickup device and optical disc drive of the present invention can be used effectively as an optical information recorder for reading and/or writing information optically from/on an optical information storage medium with multiple storage layers using a laser light source.

What is claimed is:

1. An optical pickup device with the ability to perform read and/or write operation(s) on an optical disc with multiple storage layers, the device comprising:
first and second light sources that are driven selectively and that emit blue and red light beams, respectively;
an optical element for splitting the blue and red light beams emitted into main and sub-blue beams and main and sub-red beams, respectively;
first and second photodetectors that receive the main and sub-blue beams that have been emitted from the first light source and then reflected from the optical disc, thereby outputting electrical signals representing the intensities of the light received; and
third and fourth photodetectors that receive the main and sub-red beams that have been emitted from the second light source and then reflected from the optical disc, thereby outputting electrical signals representing the intensities of the light received,
wherein a dead zone that outputs no electrical signal representing the intensity of the light received is provided for respective parts of the second and fourth photodetectors.

2. The optical pickup device of claim 1, wherein the dead zone is provided for the second photodetector so as to cross the second photodetector in a direction A corresponding to a tangential direction for the optical disc.

3. The optical pickup device of claim 2, wherein the dead zone is provided for the fourth photodetector so as to cross the fourth photodetector in the direction A.

4. The optical pickup device of claim 3, wherein supposing the dead zones of the second and fourth photodetectors have widths W1 and W2, respectively, W1>W2 is satisfied.

5. The optical pickup device of claim 1, wherein the dead zones are provided for the second and fourth photodetectors so as to cross the second and fourth photodetectors in a direction B corresponding to the radial direction of the optical disc.

6. The optical pickup device of claim 1, wherein the second photodetector is divided into four photosensitive areas, and
wherein the dead zone is arranged in a cross shape between the four photosensitive areas of the second photodetector.

7. The optical pickup device of claim 6, wherein the fourth photodetector is divided into four photosensitive areas, and
wherein the dead zone is arranged in a cross shape between the four photosensitive areas of the fourth photodetector.

8. The optical pickup device of claim 7, wherein supposing the dead zones of the second and fourth photodetectors have widths W1 and W2, respectively, in a direction B corresponding to the radial direction of the optical disc, and have widths Y1 and Y2, respectively, in a direction A corresponding to a tangential direction for the optical disc,
W1≧Y1 and W2≧Y2 are satisfied.

9. The optical pickup device of claim 7, wherein supposing the dead zones of the second and fourth photodetectors have widths W1 and W2, respectively, in the direction B, W1>W2 is satisfied.

10. The optical pickup device of claim 9, wherein supposing the dead zones of the second and fourth photodetectors have widths Y1 and Y2, respectively, in the direction A, Y1>Y2 is satisfied.

11. The optical pickup device of claim 1, further comprising a third light source that emits an infrared light beam,
wherein the first, second and third light sources are driven selectively, and
wherein the optical element splits the infrared light beam emitted into main and sub-infrared beams, and
wherein the first and second photodetectors receive the main and sub-infrared beams, respectively, which have been reflected from the optical disc.

12. The optical pickup device of claim 1, wherein the second photodetector receives the main blue beam that has been reflected from a non-target storage layer that is different from the target storage layer on which the read/write operation needs to be performed.

13. The optical pickup device of claim 1, wherein the fourth photodetector receives the main red beam that has been reflected from a non-target storage layer that is different from the target storage layer on which the read/write operation needs to be performed.

14. An optical disc drive comprising:
the optical pickup device of claim 1;
a driver section for driving the first and second light sources of the optical pickup device; and
a servo section for performing a tracking control with a tracking error signal that has been generated based on either the electrical signals supplied from the first and second photodetectors of the optical pickup device or the electrical signals supplied from the third and fourth photodetectors of the optical pickup device.
